(19) United States
(12) Patent Application Publication
(10) Pub. No.: US 2016/0069125 A1
(43) Pub. Date: Mar. 10, 2016

(54) WATERPROOF DOOR WITH MOVABLE INSERT

(71) Applicants: ALEXANDER KLEINER, QIRYAT GAT (IL); GRIGORY ORENBAKH, QIRYAT GAT (IL)

(72) Inventors: ALEXANDER KLEINER, QIRYAT GAT (IL); GRIGORY ORENBAKH, QIRYAT GAT (IL)

(21) Appl. No.: 14/554,132

(22) Filed: Nov. 26, 2014

(30) Foreign Application Priority Data
Sep. 9, 2014 (IL) IL2014/234556

(51) Int. Cl. E06B 7/23

(52) U.S. Cl. CPC E06B 7/23

(57) ABSTRACT

Device that prevents the flooding of residential and office spaces during a rise in the water level, and protects these spaces from the penetration of flame, dust, smoke, and noise. The most important feature of the proposed device is a movable insert that is installed at the bottom of a standard door. The biggest advantage of the proposed insert is that the adjustment of the pressure of the sealing may be performed from inside of the protected premises. The Drive mechanism of the sealing element is comprised of two elements with beveled surfaces moving in different directions. The first element (rail 1) is moving horizontally, and the second member (element 2) is moving vertically. These two elements have grooves that house a dowel(s) which shifts the direction of the movement of element 2 when the movement of rail 1 changes.

### TECHNICAL FIELD

The present invention is intended to protect residential and office spaces from floods by preventing the penetration of water between the sides of the frame and the corresponding sides of the door (top side, bottom side, lock side, and hinge side), and through the hole of the lock. We have developed a movable insert that allows adjustment of the contact pressure of the sealing element from inside the room with the door closed; we have also designed a seal (double cord strip) and have applied a number of solutions: a safety lock for doors (patent No. 224099) which requires a gap of 2-2.5 mm between the frame and the lock side of the door (to compensate for temperature and construction-related deformations) in contrast to known designs which require a gap of 4-6 mm; and a cylinder with a water-resistant seal (patent application No. 230924) for the lock (patent No. 211924) to protect the residential and office spaces from penetration of water, fire, smoke, and dust.

### BACKGROUND ART

Under adverse weather conditions, the water level may rise considerably. Available inserts cannot protect against this rising water. Various designs of existing inserts can be found in the catalogs of a well-known European company Athmer. Most of the known constructions of movable inserts have a significant displacement of the sealing element (up to 10-12 mm)—for example, the patents in the Athmer catalogs can seal 15 mm wide and wider gaps.

### SUMMARY OF INVENTION

The present invention relates to devices that prevent the flooding of residential and office spaces during a rise in the water level, and protects these spaces from the penetration of flame, dust, smoke, noise, and includes:
(i) Door with a cavity for inserting the housing for the movable insert (in some embodiments the insert itself, without a housing).
(ii) Drive of the sealing element in the form of two elements with beveled surfaces moving in mutually perpendicular directions and interacting along the above beveled surfaces, and the elements themselves have grooves that house interim elements—for example, pins—that reverse the direction of movement of the slave member when the direction of movement of the driving member reverses.
(iii) Adjustment of the pressure of the sealing element is performed from inside of the protected premises.
(iv) Double cord strip seal developed on the basis of the cord of a known O-ring seal.

### BRIEF DESCRIPTION OF DRAWINGS

FIG. 1 (front view) shows drive E for axial displacement of the rail 1 and for vertical movement of the element 2

FIG. 1a shows cross-section A-A in FIG. 1

FIG. 1b shows part B in FIG. 1a, enlarged

FIG. 1c shows part C in FIG. 1a, enlarged

FIG. 1d shows the Double cord strip in DETAIL C, enlarged

FIG. 2 shows part E in FIG. 1, enlarged

FIG. 2a shows cross-section A-A in FIG. 2.

FIG. 2b shows cross-section B-B in FIG. 2

FIG. 2c shows cross-section C-C in FIG. 2, enlarged

FIG. 2d shows screw 14 for displacement of rail 1, and nut 10a

FIG. 2e shows screw 14 for displacement of rail 1, head of screw 14a and socket 14b for the key

FIG. 3 (right view) shows the assembled device in housing 13 and parts from the end.

FIG. 3a (isometric view) shows assembled device and the end of the sealing element 5.

### DETAILED DESCRIPTION OF THE INVENTION

The subsequent description of the proposed patent presents its preferred design, accompanied by drawings showing how to practically use the patent. Other design solutions that conform to the formula of the patent and cannot be considered as independent patents are viable within the framework of this patent.

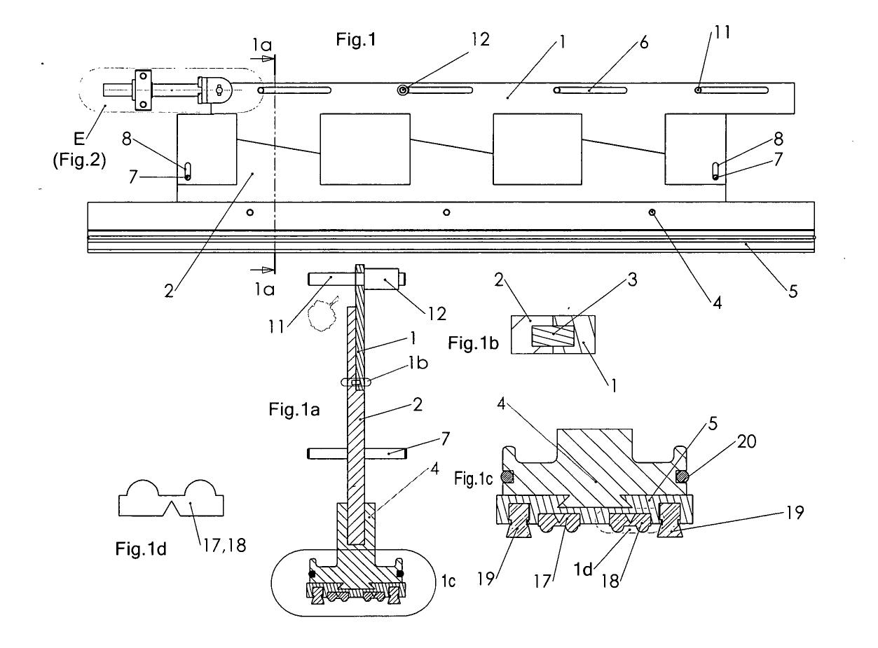

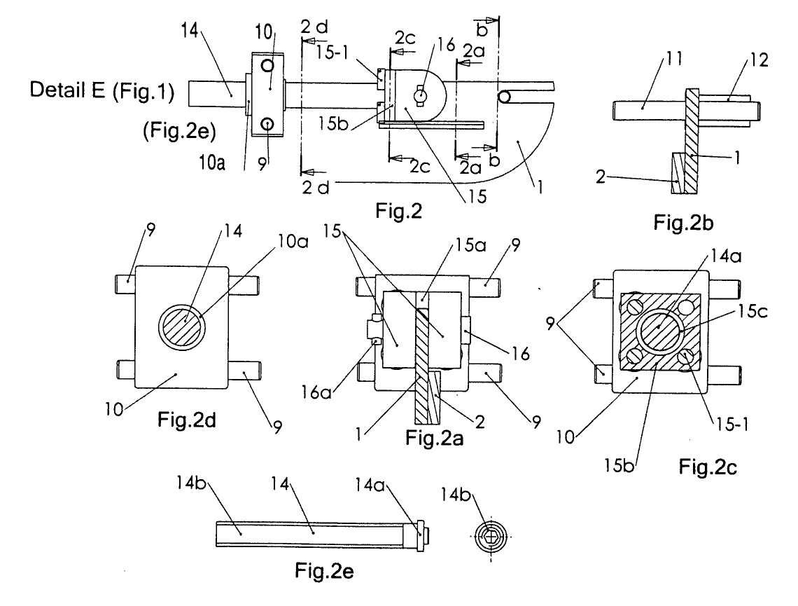

Most designs of the mobile inserts are known to use devices that secure the seal member to the surface to be protected when the door is closed. The use of an insufficiently rigid seal allows the impact of the water moving at high speed (dam break, heavy rain, etc.) to overcome the resistance of the sealing element, and flood the space behind the seal (different types of seals are shown in “Athmer automatic door seals catalogue: Auflaufdichtung V BD, groove width 15 mm”). In the proposed design it is impossible to overcome the rigid double cord strip seal (FIG. 1d, 17, 18), and rail 1 is retained by a threaded coupling (screw-nut E, FIG. 1, FIG. 2), in which nut 10a is fixed. The direction of screw 14 can be changed only from the 14b side (FIG. 2e).

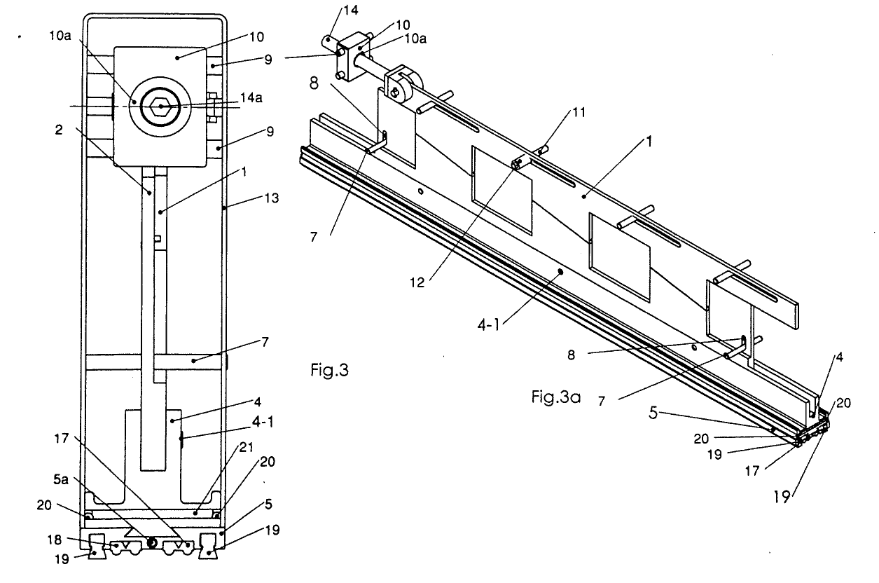

The construction shown in FIG. 1 contains a rail 1 that has grooves 6 and pins 11 that guide rail 1 and limiting its movement. Rail 1 is located between vertical wall of the element 2 and bush 12. Said rail 1 is set in motion by mechanism E: screw 14 and immovable nut 10a. Nut 10a is mounted in housing 10 whose rotation is prevented by pin 9 (part E, FIG. 1, FIG. 2). Part 15 (FIG. 2a) has a groove 15a (cross-section A-A) that includes rail 1. Said rail 1 is fixed in groove 6 by axis 16 fixed by pin 16a. Part 15 has a round recess 15c which includes head 14a of screw 14 (FIG. 2c). Cover 15b (cross-section C-C, part E, FIG. 2) covers recess 15c, in which head 14a of screw 14 can rotate and displace part 15 together with rail 1 during rotation of screw 14. Cover 15b clamping to part 15 by bolts 15-1. Screw 14 (FIG. 2e) has socket 14b whose shape and size correspond to the key (not shown) that rotates screw 14 and moves parts 15 and rail 1 when setting the clamping force of the sealing element 5 to the floor. When rail 1 moves in the direction of mechanism E (FIG. 1), pin 3 (part B in FIG. 1a, 1b) is displacing downward part 2, housing 4 and sealing element 5. Seals 20 and 21 of the housing 4 (type o-ring cord) prevents penetration of water into the housing 13. The movement of part 2 is limited by the length of groove 8 wherein pins 7 are fixedly mounted. The length of groove 8 is determined by the length of groove 6 that takes into consideration the taper rate of rail 1. The clamping force of the sealing element to the floor is determined by the ability to open/close the door. In this case, the lower taper rate of parts 1 and 2 allows a finer adjustment. Pin 3 freely mounted in the groove of rail 1 and is press-fitted into part 2. In this specific case, there are three such pins. The grooves are parallel to the bevel in which parts 1 and 2 move. Part 2 is connected to housing 4 by pins 4-1 (FIG. 1). Housing 4 is connected to the sealing element (by part 5) with a dovetail joint, which allows easy replacement of the seal. For this purpose, a “knockout” (not shown) is screwed into threaded hole 5a (FIG. 3) of part 5, and part 5 is removed. As an example, two brushes 19 that clean the floor and the double cord strip 17, 18 are connected to part 5.

The proposed invention provides a constant and easily adjustable clamping force of the sealing element to the floor or to the upper bridge of the frame. Unlike other solutions, the proposed invention allows a “zero clearance” that provides the minimum pressure on the surface to be protected, and there is no penetration of water into the room during a small flood, which is very important for the elderly and children: as soon as the water subsides, the door can be easily opened. This design differs from all known designs by the fact that the insert drive has no parts at the external side of the door. This ensures a reliable seal of the gap between the sides of the door and the frame.

Based on the experience of using the seals in hydraulic systems, we have developed a design for the insert that provides a seal of the gap between the upright parts of the door frame and the door (FIG. 1 and FIG. 3) 17, 18 (double cord strip). This structure is two O-ring cords in a rubber band with a slot to facilitate the transverse deformation of the seal during installation. Besides, the absence of external parts (plungers of spring inserts) allows to integrate a flexible curtain (e.g., LORIENT door seals catalogue: Acoustic, smoke & fire containment systems—LAS9050 & LAS9070 Finger Guard Seals) covering the entire height of the hinge side as additional protection of the room from a flood or fire; such a curtain can be installed on the indoor or outdoor side (and even on both sides). In the proposed design, the clamping force controller of the sealing element (screw 14, FIG. 2 part E) is located on the indoor side of the door. Access to the clamping force controller is possible from inside the room both in a closed and an open door position. This means that if the water begins to rise and penetrate the room, it is possible to increase the clamping force of the sealing element to the floor by rotating screw 14 until the leak in the gap between the floor and the seal is stopped. To gain access to screw 14, it is necessary to open the lid (not shown) on the indoor side of the door. If the flood ends and the door is hard to open, it is possible to reduce the clamping force between the seal and the floor in the same manner. The same holds true for the upper insert, if present. The ability to control the clamping force from inside the room is a very important feature of this design. To reduce the coefficient of friction between the protected surface and the sealing element, a special lubricant (e.g., a silicone-based oil) that provides a good seal, minimum friction losses, durability and other important properties can be used.

1. Door with a cavity for inserting the housing for the movable insert (in some embodiments the insert itself, without a housing).

2. Drive of the sealing element in the form of two elements with beveled surfaces moving in mutually perpendicular directions and interacting along the above beveled surfaces, and the elements themselves have grooves that house interim elements—for example, pins—that reverse the direction of movement of the slave member when the direction of movement of the driving member reverses.

3. Adjustment of pressure of the sealing element according to claim 2 is performed from inside of the protected premises.

4. Double cord strip seal developed on the basis of an O-ring seal cord.

5. The design of the insert drive according to claim 2 ensures a minimum constant clamping force, while maintaining a certain degree of protection in a flood or a fire at a zero gap between the protected surface and the sealing element.

6. The design of the drive according to claim 2 allows to remotely control the clamping force of the seal to the floor and to the top of the frame (if there is an upper insert) from outside the protected space.
